(19) United States
(12) Patent Application Publication
(10) Pub. No.: US 2024/0345386 A1
(43) Pub. Date: Oct. 17, 2024

(54) Systems And Methods Of Reduced Condensation Microscopy

(71) Applicant: Life Technologies Corporation, Carlsbad, CA (US)

(72) Inventors: Alexander B. Sheehan, Shoreline, WA (US); Paul Boeschoten, Bothell, WA (US); Andrew Gunderson, Snohomish, WA (US); Christopher Martin, Snohomish, WA (US); Frank Blane Metting, Bothell, WA (US); Jay Lakan Meyer, Snohomish, WA (US); Terence Tak-Shing Tam, Bothell, WA (US)

(21) Appl. No.: 18/434,479

(22) Filed: Feb. 6, 2024

Related U.S. Application Data
(60) Provisional application No. 63/483,355, filed on Feb. 6, 2023.

(51) Int. Cl. G02B 27/00; G02B 21/30

(52) U.S. Cl. CPC G02B 27/0006; G02B 21/30

(57) ABSTRACT

A system for sample imaging includes a control unit for delivering conditioned air, and a specimen chamber that receives the conditioned air from the control unit. The specimen chamber includes a chamber housing having an upper face, a lower face opposite the upper face and configured to face an imaging lens, and walls that extend vertically between the upper and lower faces. The walls define an interior volume of the specimen chamber. The specimen chamber includes an air actuator unit configured to direct conditioned air to a target location alongside the lower face for inhibiting or at least reducing condensation accumulation on the imaging lens.

### CROSS-REFERENCE TO RELATED APPLICATIONS

This application claims benefit to U.S. Provisional Patent Application No. 63/483,355, filed Feb. 6, 2023, the entirety of which is incorporated by reference herein.

### TECHNICAL FIELD

The present disclosure relates to the field of microscopy, in particular the field of components for effecting localized environmental conditions.

### BACKGROUND

To date, those in the field have encountered difficulty in designing an on-stage incubation chamber that is compatible with a variety of sample containers (e.g., vessel plates) while also creating an air-tight seal with the various sample containers. This tends to be problematic because gaps between the bottom edge of the vessel plate and the incubation chamber can allow humid gas to escape. The microscope objective lenses are often located directly beneath the part of the stage where the incubation chamber sits and are typically much colder in temperature than the escaping humid gas. In such instances, humid air that escapes the incubation chamber (e.g., through gaps between the vessel plate and the chamber) and contacts the objective lenses tends to condense on the lenses, which can cause imaging problems.

One option to combat condensation is to use a heating jacket which warms the objective to raise its dewpoint above the point of condensation. Such an approach, however, is primarily used with water-immersion optics to keep the sample from being cooled by the objective, and the solution thus is not useful with other kinds of microscopy. Heating jackets can also require physical access to the objective area of the microscope and will not work on microscopes which have rotating objective turrets. Other options to address fogging including stopping an experiment to dry the objective and/or to use an anti-fogging agent, but the efficacy of these methods is limited. Accordingly, there is a long-felt need in the art for improved systems for incubation chambers that can be used with minimal or even no fogging of the objective lens used to observe sample within the incubation chamber.

### SUMMARY

In meeting the described needs, the present disclosure provides a system for sample imaging, the system comprising: a specimen chamber configured to contain a local environment therein; and an air actuator, the specimen chamber being configured such that air encouraged by the actuator is directed between the specimen chamber and an objective lens, the air being directed so as to reduce or eliminate condensation on the objective lens.

In certain aspects, a specimen chamber for use with a sample imager includes a chamber housing that has a first face and a second face opposite each other along a first direction, wherein the first face is configured to face an imaging lens, the second face is configured to mount with a lid having a window, and the first face is spaced from the second face in a lens-facing direction along the first direction. The chamber housing includes first and second endwalls opposite each other along a second direction substantially perpendicular to the first direction. The chamber housing also includes first and second sidewalls opposite each other along a third direction substantially perpendicular to the first and second directions, so that the first and second endwalls and first and second sidewalls substantially enclose an interior volume with respect to the first and second directions. The interior volume is configured to contain a local environment therein. The chamber housing includes an air actuator unit that is configured to direct conditioned air to a target location alongside the first face and spaced from the first face in the lens-facing direction. The conditioned air is configured to inhibit or at least reduce condensation accumulation on the imaging lens.

In certain aspects, a system for sample imaging includes a control unit for delivering conditioned air, and a specimen chamber that receives the conditioned air from the control unit. The specimen chamber includes a chamber housing having an upper face, a lower face opposite the upper face and configured to face an imaging lens, and walls that extend vertically between the upper and lower faces. The walls define an interior volume of the specimen chamber. The specimen chamber includes an air actuator unit configured to direct conditioned air to a target location alongside the lower face for inhibiting or at least reducing condensation accumulation on the imaging lens.

In certain aspects, the specimen chamber comprises a feature that supports a sample container disposed within the specimen chamber. In some embodiments, the specimen chamber comprises a lower region for engaging with a specimen container. In some embodiments, the lower region comprises a first heating element. In some embodiments, the first heating element is configured to heat the specimen chamber to a range of about 30° C. to about 40° C. In some embodiments, the heating element further heats the air encouraged by the air actuator. In some embodiments, the specimen chamber comprises a lid. In some embodiments, the lid comprises a second heating element. In some embodiments, the second heating element is configured to heat the specimen chamber to a range of about 30° C. to about 40° C.

In certain aspects, the chamber comprises a manifold and an outlet, wherein the manifold is configured to direct air encouraged by the actuator to the outlet. In some embodiments, the outlet is in register with the objective lens and in proximity to the objective lens such that air exiting the outlet impinges on the objective lens. In some embodiments, the outlet is moveable. In some embodiments, the outlet is slidable, rotatable, or both. In some embodiments, the manifold further comprises one or more sensors. In some embodiments, the one or more sensors comprise a temperature sensor.

In certain aspects the system further comprises a control unit that delivers a conditioned air to the specimen chamber. In some embodiments, the control unit comprises a gas mixing manifold. In some embodiments, a gas mixture within the gas mixing manifold comprises one or more gases selected from oxygen, carbon dioxide, nitrogen, and standard air, the gases balanced to a selected mixture of concentrations. In some embodiments, the control unit comprises a pump configured to encourage the conditioned air to a fluid inlet of the specimen chamber. In some embodiments, the pump is positioned internal to the control unit. In some embodiments, the conditioned air comprises humidified air or heated humidified air. In some embodiments, the conditioned air comprises dried air or heated dried air. In some embodiments, the humidified air comprises a humidity of about 50% to about 90% humidity. In some embodiments, the selected mixture of concentrations comprises from about 5% to about 12% carbon dioxide. In some embodiments, the selected mixture of concentrations comprises up about 21% oxygen. In some embodiments, the selected mixture of concentrations comprises from about 67% to about 95% nitrogen.

In certain aspects, the system of the present disclosure as described above is configured for operation such that the minimum temperature among all locations of a sample container located within the specimen chamber is within about 15% of the maximum temperature among all locations of the sample container.

Also provided is a method comprising: operating a system for improved imaging as disclosed herein so as (1) reduce or eliminate condensation on the objective lens, (2) maintain a first environment within the specimen chamber that differs in one or more of temperature, humidity, and gas mixture composition from an ambient environment exterior to the specimen chamber, or both (1) and (2).

In some embodiments, the method further comprises operating the system as disclosed herein so as to maintain a second environment within the specimen chamber that differs in one or more of temperature, humidity, and gas mixture composition from an ambient environment exterior to the specimen chamber, the second environment differing from the first environment. In some embodiments, wherein the operating is performed such that during the operating, the minimum temperature of all locations of a sample container located within the specimen chamber is within about 15% of the maximum temperature of all locations of the sample container.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. For example, the attached figures illustrate certain features of the invention, but these figures should not be considered limiting or exhaustive, as the disclosed technology can vary from what is contained in the figures.

In the drawings:

FIG. 1 depicts an exemplary incubator system that includes a control unit and an incubated specimen chamber, according to an embodiment of the present disclosure.

FIG. 2 depicts an exploded perspective view of the exemplary control unit illustrated in FIG. 1, according to an embodiment of the present disclosure.

FIG. 3 depicts a rear view of the exemplary control unit illustrated in FIG. 1, showing an interface panel that includes a gas inlet, a filter for an internal air pump, and connections for electronics.

FIG. 4A depicts a partially exploded perspective view of the exemplary specimen chamber illustrated in FIG. 1, showing a chamber housing and a removable lid having a thermally insulating film, according to embodiments of the present disclosure.

FIG. 4B depicts an exploded perspective view of select components of the exemplary chamber housing illustrated in FIG. 4A, including an air actuation unit according to an embodiment of the present disclosure.

FIG. 5A depicts an enlarged, perspective view of a portion of the exemplary specimen chamber illustrated in FIG. 4A, with part of the chamber housing removed for illustrative purposes to show part of the exemplary air actuation unit.

FIG. 5B depicts a perspective view of the exemplary air actuation unit illustrated in FIG. 5A.

FIG. 5C depicts an enlarged, perspective view of a portion of the exemplary specimen chamber illustrated in FIG. 4A, showing an air filter unit of the exemplary air actuation unit.

FIG. 5D depicts a perspective view of the exemplary air actuation unit illustrated in illustrated in FIG. 4A.

FIG. 5E depicts a perspective, sectional view of the air actuation unit illustrated in FIG. 5D.

FIG. 5F depicts an end sectional view of the air actuation unit disposed in relation to adjacent components of the chamber housing illustrated in FIG. 4A.

FIG. 5G is a top view of the air actuation unit illustrated in FIG. 5D.

FIGS. 6A and 6B depict perspective views of a fan for use with the air actuation unit illustrated in FIG. 5D.

FIG. 7 depicts a bottom perspective view of the exemplary specimen chamber illustrated in FIG. 4A.

FIGS. 8A and 8B are photographs showing exemplary demonstrations of problematic condensation accumulated on objective lenses in a microscope, which condensation is resolved by embodiments of the system disclosed herein.

FIG. 9 depicts an exemplary method as contemplated by the present invention.

FIG. 10 depicts a schematic showing heated air being directed across an objective lens for removing and/or preventing condensation on the lens, according to an embodiment of the present disclosure.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

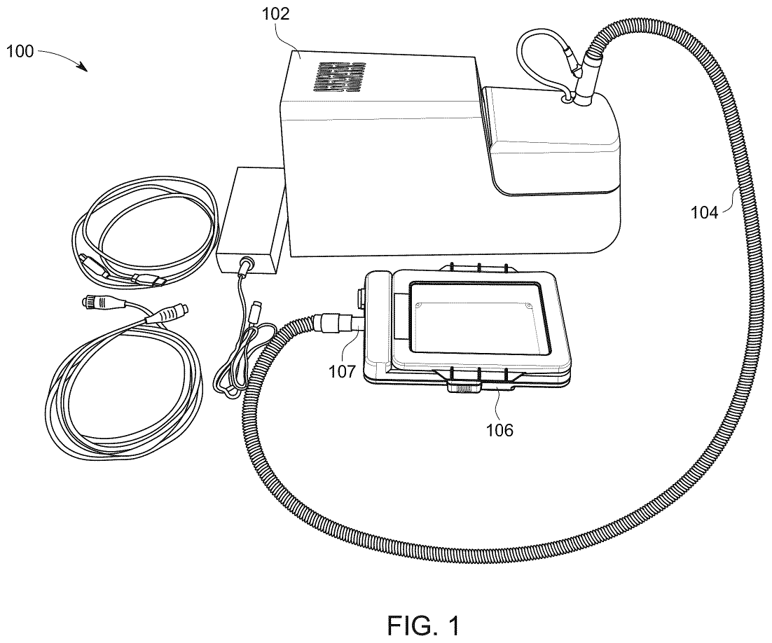

Referring now to FIG. 1, an incubator system 100 according to the present disclosure includes a control unit 102 and a specimen incubation chamber 106 (also referred to herein as a “specimen chamber” 106) connected to the control unit 102. The incubator system 100 can also be referred to herein as an “incubator” 100. The control unit 102 is configured to control and adjust a local environment contained within the specimen chamber 106. As shown, the control unit 102 can be connected via at least one connector 104 to at least one inlet 107 of the specimen chamber 106.

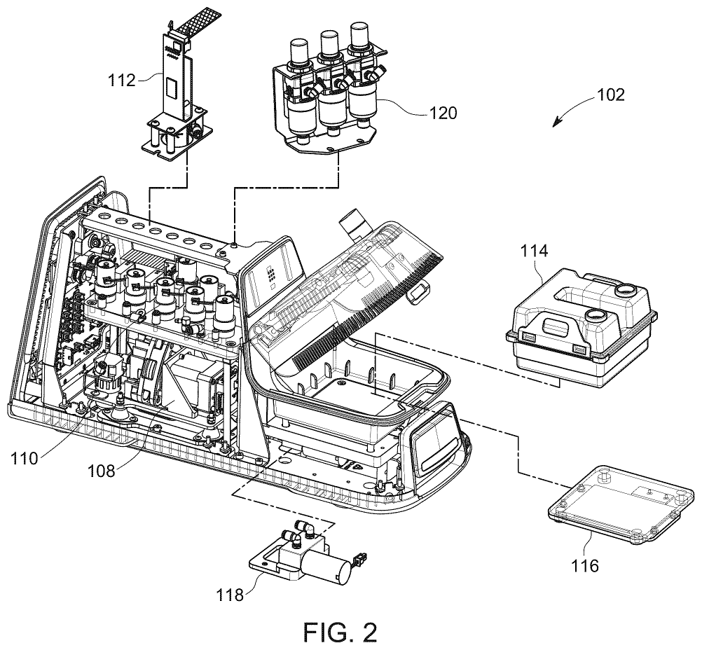

Referring now to FIG. 2, the control unit 102 can include a gas mixing manifold 110, which can allow for mixing of gases received from one or more sources. In some embodiments, the one or sources can include one or more external sources, that is, external to the manifold 110, including for example, one or more gas tanks, gas generators, or other external gas supplies. In some embodiments, the one or more sources can include one or more sources internal to the manifold 110. The manifold 110 can include a plurality of gas regulator valves and can be connected to external gas supplies, which external gases can be mixed within the manifold to the required experimental conditions. The gas supplies can include but are not limited to nitrogen (N₂), carbon dioxide (CO₂), oxygen (O₂), air, and the like, including one or more combinations thereof. Valves connected to the external gas supplies can be actuated to allow and stop the passage of the external gases into the manifold 110; the manifold 110 can include one or more sensors configured to detect one or more gas levels. In this way, a user can connect the manifold 110 to the desired gases and then, by actuation of the valves, blend the gases to arrive at a mixture within the manifold 110 that is to the required experimental conditions. For example, the user can set the O₂ level to a value in the range of from about 0% to about 21% including any and all intermediate values. Similarly, the user can set the CO₂ level to a value in the range of from about 0% to about 20% including any and all intermediate values.

The composition of the gas mixture within the manifold 110 can be changed over time, that is, from a first blend at a first time to a second blend at a second time, which can in turn allow a user to expose a sample in fluid communication with the gas manifold 110 to different gas conditions at different times. A pump 108, such as an air pump 108, can be used to take in air from exterior to the control unit and/or gases from the gas mixing manifold 110 of the control unit. Control unit 102 can include a water reservoir 114, which can be located within the control unit. In some instances, the lower portion of the reservoir can be aluminum or another thermally conductive material, and the upper portion can be polycarbonate or other plastic. By way of non-limiting examples, the lower portion of the reservoir can be a material that conducts heat efficiently, and the upper portion of the reservoir can be clear to allow the user to see the water level therein. A heater, including for example a heater plate 116 can be used to heat the water reservoir 114, which can in turn give rise to a humidified air. The heater plate 116 can be a 60 Watt (W) heater, by way of a non-limiting example, and can include a digital temperature sensor. Conditioned air, which can include at least some of the contents of the gas mixing manifold 110 and/or a humidified air derived from heating of the water reservoir 114, can be delivered via the connector 104 (see FIG. 1) from the control unit 102 to the specimen chamber 106. For example, the humidity in the specimen chamber 106 is controlled by one or more valves on the gas mixing manifold 110. A valve can be actuated to allow the gas mixture to flow over the water reservoir 114, thereby humidifying the gas mixture. If less humidity is preferred, the valve is at least partially closed and a second valve opens, allowing an amount of the gas mixture to bypass the heated water reservoir 114. In some embodiments, the connector 104 can also include a heating element that heats air and allows a user to deliver to the specimen chamber 106 air at a desired temperature. The pump 108 can be located within control unit 102 and can deliver conditioned air (or non-conditioned air) from the control unit 102 via the connector 104 to the specimen chamber 106. In some embodiments, humidified air provides for an environment where sample media either does not evaporate or evaporates at a reduced rate, allowing the user to perform longer-term experiments while maintaining sample viability and more accurate sample media volume levels in the absence of evaporation.

As shown in FIG. 2, the control unit 102 can include one or more of various sensors, such as an oxygen sensor 118 and a carbon dioxide (CO₂) sensor 112, by way of non-limiting examples. The control unit 102 can also include one or more gas filter/regulators 120. The gas filter/regulators 120 can be used to, for instance, modulate the delivery of gases to the gas mixing manifold 110 from exterior sources of gas and to remove particulate from the circulating air via filtration. In some embodiments, the filter/regulators remove particulate greater than about 5 μm from the circulating air. The filter/regulators operate to control the pressure of gas to the manifold 110. In some embodiments, the circulating gas is regulated to a pressure of about 35 psi. The control unit 102 can include one or more sensors that report one or more of a temperature, a humidity, and a gas content of a conditioned air delivered from the control unit 102 via connector 104. The sensors can be mounted on or adjacent to the manifold 110, or in fluid communication with the manifold 110.

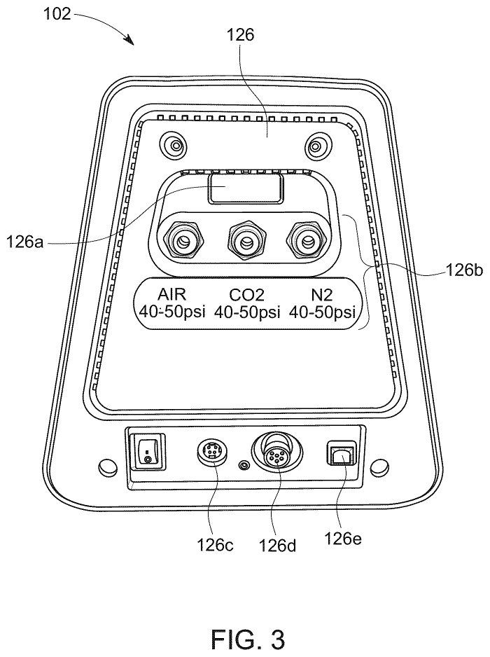

FIG. 3 provides an exterior view showing a user interface panel 126, which can be located at the rear of the control unit 102. As shown, the user interface panel 126 of the control unit 102 can include an air filter 126a that filters air drawn in by the air pump 108 shown in FIG. 2. The control unit 102 can include one or more gas inlets 126b, which gas inlets 126b can be connected to external gas supplies, for example, supplies of O₂, N₂, CO₂ gas and/or air. The control unit 102 can also include a power supply connection 126c, a data and/or power connection 126d to the specimen chamber 106 (see FIG. 1), and a data port 126e, for example, a USB port, that allows for connection between the control unit 102 and an external computer or other control device.

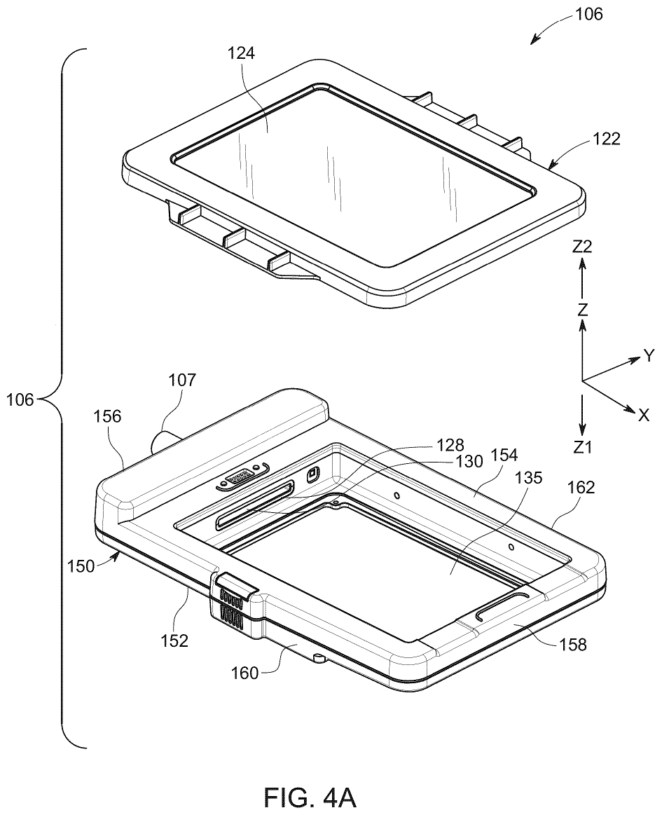

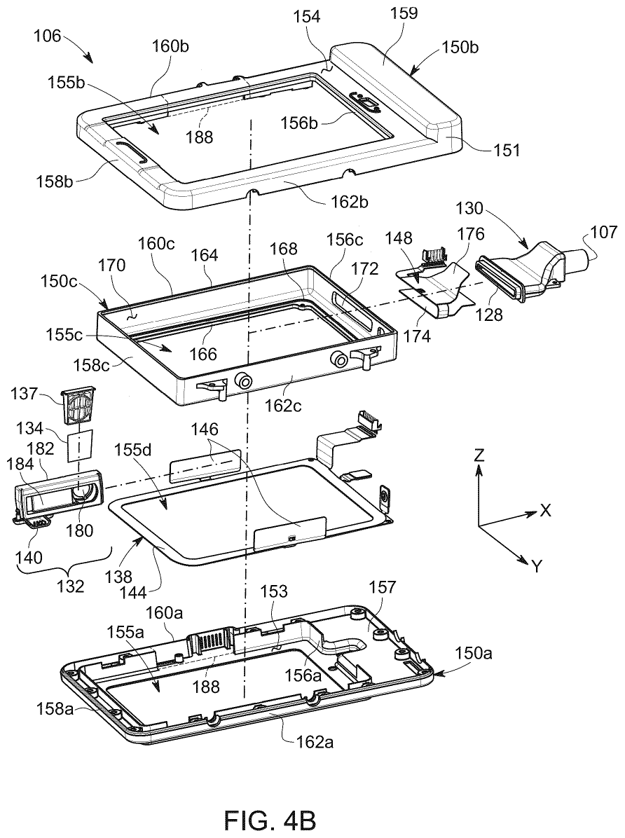

Referring now to FIG. 4A, a partial exploded, top perspective view of the specimen chamber 106 is shown according to an exemplary embodiment. As shown, the specimen chamber 106 can include a chamber housing 150 that defines an interior volume 135 for holding therein one or more sample containers having sample media. The interior volume 135 can also be referred to herein as the “interior” 135 of the specimen chamber 106. The specimen chamber 106 also preferably includes a cover or “lid” 122 for coupling with the chamber housing 150 and enclosing a portion of the interior volume 135. The lid 122 preferably includes a window 124 for viewing sample media located in the interior volume 135 of the specimen chamber 106. The lid 122 is discussed in more detail below. The chamber housing 150 includes at least one inlet 107, which can receive conditioned air from the control unit 102 via the at least one connector 104 (see FIG. 1) for delivery to the interior volume 135.

The chamber housing 150 has a first face 152 and a second face 154 opposite the first face 152 along a first direction Z. The first face 152 is configured to face an imaging lens, such as an objective lens 142, along the first direction Z. The second face 154 is configured to mount with the lid 122. The lid 122 can be securably mountable to the second face 154. Alternatively, the lid 122 can be a lift-off lid that is not otherwise secured to the chamber housing 150.

The first face 152 is spaced from the second face 154 of the chamber housing 150 in a lens-facing direction Z1 along the first direction Z, while the second face 154 is spaced from the first face 152 in a lens-away direction Z2 opposite the lens-facing direction Z1. It should be appreciated that the lens-facing direction Z1 and the lens-away direction Z2 are each mono-directional components of the first direction Z, which is bi-directional. The chamber housing 150 also includes first and second endwalls 156, 158 opposite each other along a second direction X substantially perpendicular to the first direction Z. The chamber housing 150 further includes first and second sidewalls 160, 162 opposite each other along a third direction Y substantially perpendicular to the first and second directions. The first and second endwalls 156, 158 and the first and second sidewalls 160, 162 substantially enclose the interior volume 135 with respect to the second and third X, Y directions. The interior volume 135 is configured to contain a local environment therein, preferably an incubated local environment for receiving one or more sample containers. The specimen container 106 is configured so that a user can remove the lid 122 from the chamber housing 150, place one or more sample containers within the interior volume 135, and replace the lid 122 atop the second face 154, thereby enclosing the interior volume 135 with respect to the lens-away direction Z2.

In the illustrated embodiment, the specimen chamber 106 is configured to be placed atop a stage (e.g., a movable x-, y-stage) of a microscopic imaging system. Accordingly, during use, the first direction Z is the vertical direction and the second and third directions X, Y are each horizontal directions when the specimen chamber 106 is placed at such an orientation. In such embodiments, the lens-facing direction Z1 can be characterized as the “downward” direction Z1, and the lens-away direction Z2 can be characterized as the “upward” direction Z2. It should be appreciated that, as used herein with reference to the illustrated embodiments (e.g., when referring to spatial relationships between various features), directional terms can be used to indicate spatial relationships between various features of the specimen chamber 106. For example, the terms “downward”, “down”, “under”, “bottom”, “beneath”, and derivatives thereof refer to the downward direction Z1; and the terms “upward”, “upper”, “above”, “top”, “atop”, and derivatives thereof refer to the upward direction Z2. By way of some specific, non-limiting examples, when referring to the illustrated embodiments herein, the first face 152 of the housing body 150 can also be referred to as a “lower” face 152; and the second face 154 of the housing body 150 can also be referred to as an “upper” face 154. Similar such directional terms are also used herein to describe other features of the illustrated embodiment. In other embodiments, however, that specimen chamber 106 can be adapted so that the first direction Z is offset from vertical (and by extension, one or both of the second and third directions can be offset from horizontal) during use. It should be appreciated that, unless stated otherwise herein, the foregoing spatial relationships of the various described features also indicate spatial relationships between various features in embodiments where the first direction Z is offset from vertical. By way of two such examples, the specimen chamber 106 can be adapted for use with a microscopic imaging system in which the imaging lens faces downward instead of upward, or alternatively faces horizontally instead of vertically. The reader will appreciate that, in such alternative configurations, it is the “bottom face” 152 of the chamber housing 150 that faces the imaging lens, even if the lower face 152 is positioned above the upper face 154 (in the case of a downward facing lens), or even if the lower face 152 and the upper face 154 are spaced from each other horizontally instead of vertically (in the case of a horizontally facing lens). Summarized differently, the directional terms used herein indicate spatial relationships between various features and, unless stated otherwise herein, those spatial relationships will also apply regardless of the specific orientation in which the specimen chamber 106 is oriented in three-dimensional space.

Referring now to FIG. 4B, the chamber housing 150 can include a first or “lower” housing body 150a and a second or “upper” housing body 150b that are connectable to each other. In the illustrated embodiment, the lower housing body 150a defines the lower face 152, the upper housing body 150b defines the upper face 154, and the lower and upper housing bodies 150a,b are connectable to each other in a sandwich-like fashion. As shown, the lower and upper housing bodies 150a,b can each include respective first and second body endwalls 156a,b, 158a,b and first and second body sidewalls 160a,b, 162a,b, which combine to form portions of the first and second endwalls 156, 158 and first and second sidewalls 160, 160 of the chamber housing 150 when the lower and upper housing bodies 150a,b are coupled together. The lower and upper housing bodies 150a,b also preferably each define a central aperture 155a,b extending therethrough along the first direction Z. The central aperture 155a of the lower housing body 150a provides an open, unobstructed space between the specimen chamber 106 and the imaging lens for obtaining clear images of sample media placed in the specimen chamber 106. The central aperture 155b of the upper housing body 150b provides an opening through which a user can place one or more sample containers into the interior volume 135 of the specimen chamber 106 while the lid 122 is removed.

The lower housing portion 150a preferably also has an interior support surface 153, which can extend around an interior periphery of the endwalls 156a, 158a and sidewalls 160a, 162a in a rim-like fashion. The interior support surface 157 can be configured to support various features of the specimen chamber 106, as described in more detail below. The lower housing portion 150a also preferably has a platform surface 157, which can be located on a side of the first endwall 156a opposite the central aperture 155a along the second direction X. The platform surface 157 can be configured to support various structural features of the chamber housing 150, such as circuitry (e.g., one or more printed circuit boards (PCBs) and the like), and air delivery components, as described in more detail below. The upper housing portion 150b preferably has a canopy portion 159, which can overlay at least a portion of the platform surface 157 and can be configured to cover some or all of the various structure features supported by the platform surface 157.

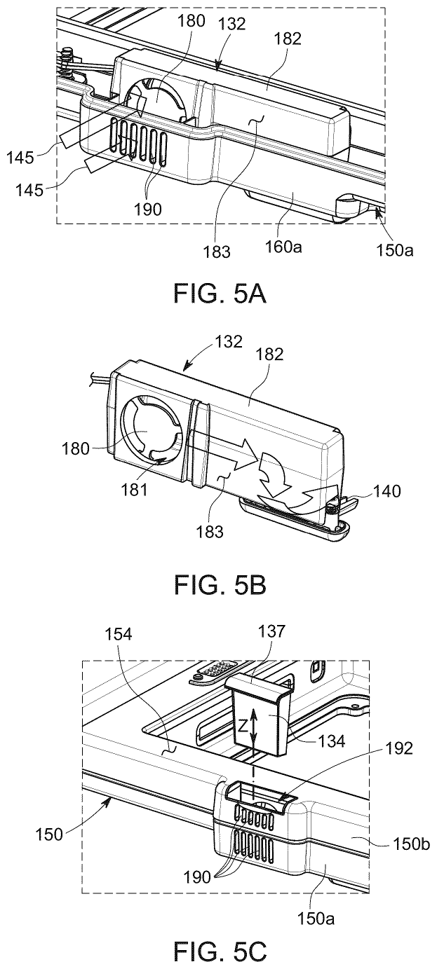

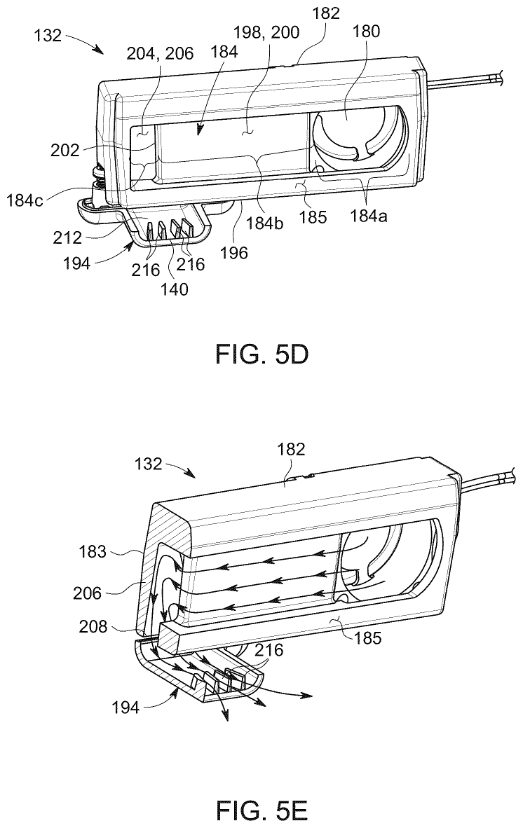

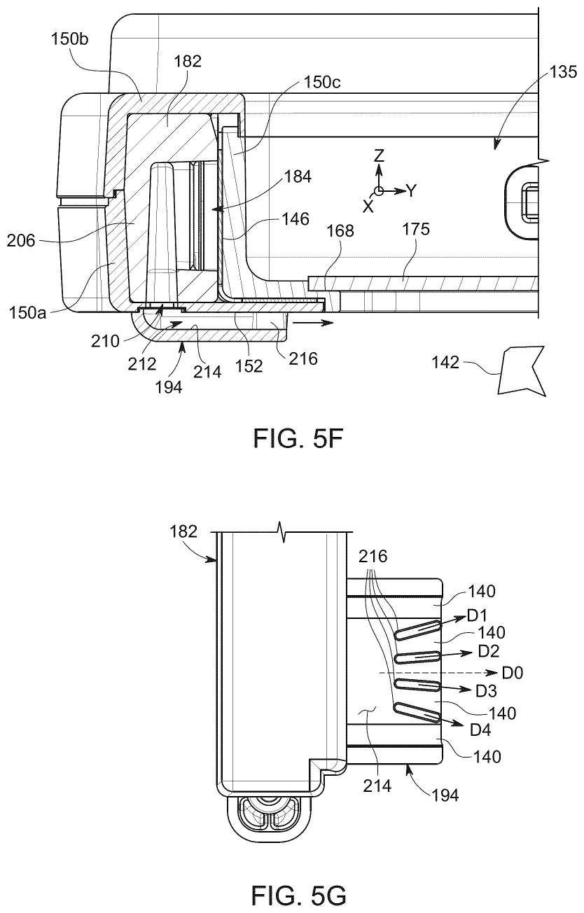

The chamber housing 150 can also include a seat member 150c that is disposed between the lower and upper housing bodies 150a,b. The seat member 150c has a top end 164 and a bottom end 166 that are spaced from each other along the first direction Z. The seat member 150c also includes first and second member endwalls 156c, 158d and first and second member sidewalls 160c, 162c, which form portions of the first and second endwalls 156, 158 and first and second sidewalls 160, 160 of the chamber housing 150 when the seat member 150c is coupled together with the lower and upper housing bodies 150a,b. Interior surfaces 170 of the member endwalls 156c, 158c and member sidewalls 160c, 162c define respective portions of the interior volume 135. The first member endwall 156c can define an aperture 172 for passage of one or more vents 128 into the interior volume 135, as described in more detail below. The seat member 150c also includes a sample support surface 168 located vertically between the top and bottom ends 164, 166 and facing upward (i.e., along the upward direction Z2). The sample support surface 168 is configured to hold one or more sample containers 175 placed in the internal volume 135 of the specimen chamber 106 (see FIG. 5F). As shown, the sample support surface 168 can extend around an entire inner perimeter of the seat member 150c in a rim-like fashion and is spaced inwardly from the member endwalls 156c, 158c and member sidewalls 160c, 162c. The seat member 150c defines a central aperture 155c extending therethrough along the first direction Z. Similar to the lower housing body 150a, the central aperture 155c of the seat member provides an open, unobstructed space between the specimen chamber 106 and the imaging lens. Moreover, similar to the upper housing body 150b, the central aperture 155c of the seat member 150c also provides an upper opening through which the user places the one or more sample containers into the interior volume 135 and atop of the sample support surface 168. The seat member 150c can be made of a material providing favorable thermal conduction and insulation for incubating the interior volume 135, including aluminum, steel, titanium, by way of non-limiting examples. In such embodiments, the seat member 150c can also be referred to as a “heat spreader” 150c. It should be appreciated that the seat member 150c can optionally be made of virtually any material that is machinable, physically stable, and thermally conductive.

The specimen chamber 106 includes the at least one inlet 107, which can be in communication with a chamber manifold 130 configured to distribute the air delivered to inlet 107 to the one or more vents 128 of the specimen chamber 106. In the illustrated embodiment, the chamber manifold 130 defines the inlet 107 at one end thereof, and also defines an interior vent 128 at an opposite end thereof. The interior vent 128 is configured to extend through, or at least reside within, the aperture 172 in the first endwall 156c of the seat member 150c and to communicate air received from the inlet 107 to the interior volume 135 of the specimen chamber 106.

With continued reference to FIG. 4B, the specimen chamber 106 includes various thermal regulation features, which can be used to heat the environment within interior volume 135 to a desired temperature, such as for incubating sample media placed therein. For example, the thermal regulation features can be configured to heat the environment within the interior volume 135 to a temperature in a range of about 30° C. to about 40° C., and more particularly in a range of about 35° C. to about 40° C., and more preferably about 37° C. The thermal regulation features can also be employed for maintaining and/or adjusting temperature within the interior volume 135 as needed. Examples of such thermal regulation features will now be described. For example, the specimen chamber 106 can include a first heater 138, which can extend around a periphery of the interior volume 135. The first heater 138 can have a base heater portion 144 that extends around the periphery of the interior volume 135 and defines a central aperture 155d. The base heater portion 144 can be configured to underlay and heat the bottom end 166 of the seat member 150c as needed to maintain the desired temperature within the interior volume 135. The first heater 138 preferably also has one or more wall heater portions 146 that extend upwards along a respective sidewall or endwall of the chamber housing 150. In the illustrated embodiment, the first heater 138 includes a pair of wall heater portions 146 that extend upwardly from the base portion 138 alongside the first and second sidewalls 160a-c, 162a-c. The pair of wall heater portions 146 can be configured for heating the sidewalls 160c, 162c of the seat member to further regulate the temperature of the seat member 150c as needed to maintain the desired temperature within the interior volume 135.

The specimen chamber 106 can also include an inlet heater 148 for heating the air delivered through the chamber manifold 130. The inlet heater 148 can include lower and upper panels 174, 176 that contact upper and lower portions of the chamber manifold 130. In this manner, the inlet heater 148 can work together with (or provide redundancy to) the first heater 138 as needed to maintain the desired temperature within the interior volume 135. The first heater 138 and the inlet heater 148 also include circuitry features, such as flex circuits, tracers, connecting pins, headers, and the like, for electronically connecting the heaters 138, 148 to the control unit 102, which can include a processor executing computer readable instructions stored in computer memory for controlling operation of the heaters 138, 148, among other things. Alternatively, the heaters 138, 148 can be electronically connected to a separate electronic control unit, which can be located on-board the specimen chamber 106.

It should be appreciated that the lid 122 (see FIG. 4A) can also include one or more thermal regulator features, such as thermally insulating film(s) and/or a conductive heater, by way of non-limiting examples. The thermally insulating film(s) and/or the conductive heater can be superimposed on part or all of the window 124 of lid 122. Thus, the window 124 can also be characterized as a heater or heat insulator. The conductive heater and/or heat insulator of the lid 122 can be used, alone or in connection with the first heater 138 and/or the inlet heater 148, to heat the environment within specimen chamber 106 to a desired temperature. The thermally insulating film(s) of the lid 122 can include one or more suitable thermally insulating films, such as an indium tin oxide resistive film, by way of a non-limiting example. The specimen chamber 106 also preferably includes one or more sensors that report one or more of a temperature, a humidity, and a gas content of the environment within the interior volume 135 to the control unit 102, as described in more detail below.

With continued reference to FIG. 4B, the specimen chamber 106 includes an air circulator or “actuator” unit 132 for directing air to a target location between the interior volume 135 of the specimen chamber 106 and the imaging lens with respect to the first direction Z. Such target location is preferably alongside and underneath the lower face 152 of the housing body 150, which location can be referred to as “beneath” the specimen chamber 106. Preferably, the air actuator unit 132 is configured to direct conditioned air, that is, air having a conditioned (e.g., heated) temperature, to the target location between the interior volume 135 and the imaging lens. By heating such air and directing it to the target location, the specimen chamber 106 can effectively warm or heat the imaging lens in a manner inhibiting or at least reducing the formation of condensation thereon, thereby improving image quality. Additionally or alternatively, the heated air can be directed toward or adjacent the imaging lens in order to dry or remove any existing condensation that may have accumulated on the imaging lens, thereby improving image quality. The air actuator unit 132 includes an air actuator 180, which can be a fan 180 or other mechanism that acts to draw air, such as ambient air adjacent the specimen chamber 106, and directs the drawn air through the air actuator unit 132. The air actuator unit 132 preferably also includes a duct member 182 that directs the drawn air from the air actuator 180 along one or more channels 184 to one or more outlet vents or ports 140 facing the target location. The air actuator unit 132 can include an air actuator filter 134, which filter acts to filter air drawn into the duct member 182 by the air actuator 180. As shown, the air actuator filter 134 can be carried by a filter support 137, which can be couplable with and decouplable from the duct member 182. The air actuation unit 132 can reside in a compartment 188 defined by portions of the lower and upper housing bodies 150a,b, such as along the first sidewalls 160a,b thereof, as in the illustrated embodiment. It should be appreciated that the air actuation unit 132 can be removeable and/or replaceable from the specimen chamber 106, as described in more detail below.

Referring now to FIG. 5A, a partial view of the specimen chamber 106 is shown, with the upper housing body 150b removed for visualization purposes to show the air actuator unit 132. As shown, the air actuator 180 can draw or otherwise induct air (e.g., external, ambient air, shown by arrows 145) into the duct member 182, particularly through an opening 181 defined in an exterior face 183 of the duct member 182. The housing body 150 preferably defines vent ports 190 adjacent the air actuator 180, allowing passage of the external air into the air actuator unit 132. As shown in FIG. 5B, once drawn into the duct member 182 via the air actuator 180, the inducted air is then directed through the duct member 182 as indicated by arrows, toward the one or more outlet ports 140, which are preferably located beneath a sample container present within the interior volume 135 of the specimen chamber 106, as described in more detail below. As shown in FIG. 5C, the air actuator filter 134 and the filter support 137 can reside within a filter receptacle 192 defined by the chamber housing 150, such as by both the lower and upper housing bodies 150a,b thereof. The filter receptacle 192 and the filter support 137 can be configured for case of filter replacement by pulling the filter support 137 upward from the receptacle 192, as shown.

Referring now to FIGS. 5D-5E, an interior face 185 of the duct member 182 is shown, which interior face 185 faces toward the interior volume 135 of the specimen chamber 106. The duct member 182 defines one or more channels 184 that direct the flow of inducted air to the one or more outlet vents or ports 140. In the illustrated embodiment, the duct member 182 defines a single channel 184 that extends therethrough and defines a flow path that leads toward the one or more outlet ports 140. As shown, the air actuation unit 132 can include an outlet member 194 connectable adjacent the duct member 182, particularly adjacent an underside 196 of the duct member 182. The channel 184 can be characterized as having multiple portions, such as: a first or opening portion 184a, which can be aligned with the air actuator 180 along the third direction Y; a second or main portion 184b, which can extend along the second direction X and alongside one of the wall heater portions 146 of the first heater 138 (see FIG. 4B); and a third or re-direction portion 184c, which re-directs the flow of inducted air behind and under the lower face 152 of the housing body 150. Some exemplary air flow paths are shown in FIG. 5E for illustrative purposes. The second main portion 184b of the channel 184 can be defined between an interior face 198 of an inner wall 200 of the duct member 182 and the associated wall heater portion 146 (see FIG. 4B). The associated wall heater portion 146 can be positioned in close proximity to, or in contact with, the interior face 185 of the duct member 182. In this manner, air inducted into the channel 184 is directed along the second direction X alongside the associated wall heater portion 146, which can heat the inducted air to a temperature sufficient to inhibit or at least reduce the formation of condensation of the imaging lens. At the re-direction portion 184c of the channel 184, the inducted air is directed generally in the third direction Y around a bend located downstream of an end surface 202 of the inner wall 200. Within the re-direction portion 184c downstream of the bend, the inducted air is further re-directed downward (direction Z1) by an interior face 204 of an exterior wall 206 of the duct member 182. The downwardly re-directed air passes through a bottom opening 208 of the duct member 182 (shown in FIG. 5E) and an associated bottom opening 210 of the lower housing body 150a (shown in FIG. 5F) and into an outlet passageway 212 at least partially defined by the outlet member 194.

Referring now to FIG. 5F, the outlet passageway 212 is partially defined by an outlet base surface 214 of the outlet member 194 and can be further partially defined by the lower face 152 of the lower housing body 150a. In the illustrated embodiment, the outlet passageway 212 is defined vertically between the outlet base surface 214 of the outlet member 194 and the lower face 152 of the lower housing body 150a. As shown, the outlet base surface 214 has a bend portion, which re-directs the inducted air passing through the bottom openings 208, 210 generally along the third direction Y. The outlet base surface 214 also has a flat portion, which directs the inducted air along the outlet passageway 212 in the third direction Y and toward the target location underneath the lower face 152 of the chamber housing 150. As shown, the flat portion of the outlet base surface 214 is preferably substantially parallel with the lower face 152 of the chamber housing 150. This causes the inducted air to exit from the outlet member 194 in respective air flow directions that are substantially parallel with the lower face 152. Additionally, the outlet member 194 preferably includes guide members, such as baffles or fins 216, that protrude within the outlet passageway 212 and are configured to spread the inducted air exiting the outlet port(s) 140 along respective directions having directional components along the second direction X, thereby expanding the target location to extend alongside a larger portion of the lower face 152 of the chamber housing 150. This provides a more uniform area of conditioned (e.g., heated) air between the specimen chamber 106 and the imaging lens, thereby beneficially enhancing the inhibition (or at least reduction) of condensation formation on the imaging lens. As shown in FIG. 5G, the fins 216 are elongated along respective directions D1-D4 that diverge from each other in a downstream direction of air flow DO, thereby causing the inducted air to spread outwardly as it exits the outlet port 140. As shown in FIG. 5F, the fins 216 can extend upwardly and into contact with, or at least close proximity to, the lower face 152 of the chamber housing 150, thereby providing a plurality of outlet ports 140 between the fins 216 along the second direction X.

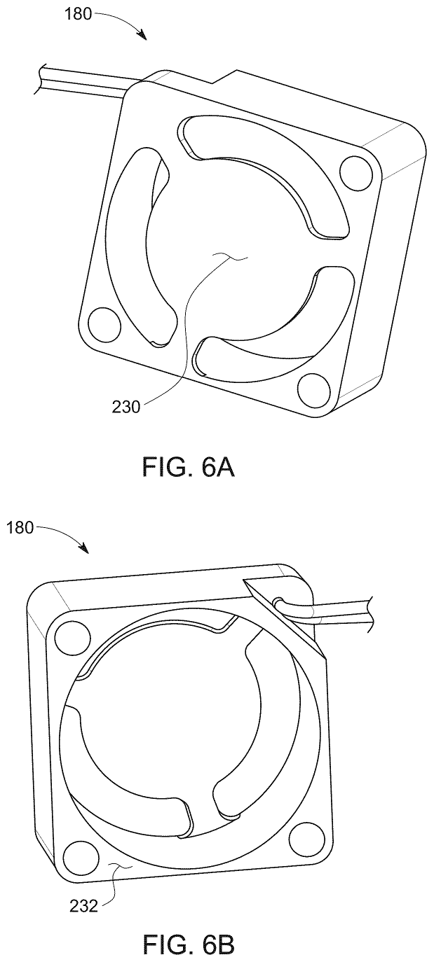

Referring now to FIGS. 6A and 6B, exemplary embodiments of an air actuator 180 are shown for use with the air actuation unit 132. In these embodiments, the air actuator 180 comprise a fan 180, which has a front face 230 (FIG. 6A) configured to be located adjacent the exterior face 183 of the duct member 182. The fan 180 also has a rear face 232 (FIG. 6B) configured to be adjacent the interior face 198 of the inner wall 200 of the duct member 182. It should be appreciated that the fan 180 provides numerous benefits for use in the air actuation unit 132. One benefit, as the inventors have discovered, is that the fan 180 is effective to inhibit or at least reduce condensation accumulation and/or fogging of objective lenses when used with various sizes and configurations of sample containers. Another such benefit is that the fan 180 also helps maintain the sample container (and the sample media therein) at a uniform temperature, thus enhancing the incubation environment of the sample media within the specimen chamber 106.

Thus, according to the embodiments described above, air, such as ambient air, can be inducted into the air actuator unit 132 and can be heated by the heater 138, and the heated air can then be directed out of one or more outlet vents or ports 140 and against, along, or nearby to an imaging lens (e.g., an objective lens 142) that is present beneath the specimen chamber 106. This heated air can in turn inhibit or at least reduce fogging and/or accumulation of condensation on the imaging lens. It should be appreciated that the air actuation unit 132 can be configured to direct heated air directly toward the imaging lens or to a region between the imaging lens and the specimen chamber 106.

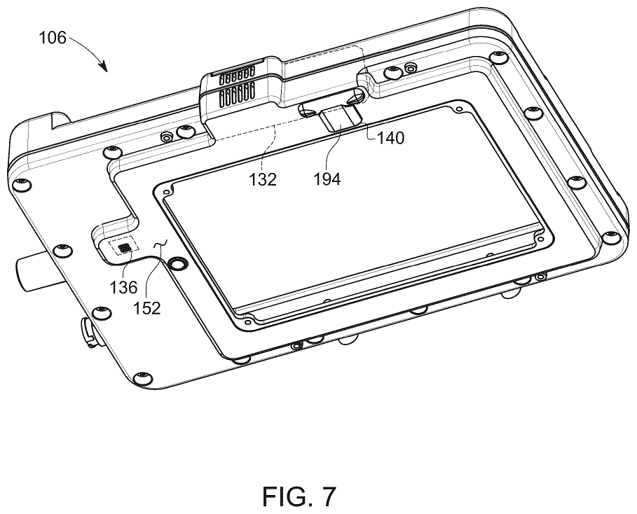

Referring now to FIG. 7, the specimen chamber 106 preferably includes at least one sensor, such as a temperature/humidity sensor 136, that monitors the environment of the target location beneath the specimen chamber 106, such as the temperature and/or humidity of the target location. The output of the temperature/humidity sensor 136 can be used to control the activity of the air actuator unit 132, heater(s) 138, 148, and/or other features of the specimen chambers 106 disclosed herein to. In this way, the disclosed incubators 100 can (1) give rise to a locally modulated environment, where the environment includes, for example, a specified temperature, humidity, within the interior of the specimen chamber 106 while (2) reducing or eliminating fogging of an imaging lens, such as an objective lens 142, that is imaging a sample or samples disposed within the specimen chamber 106.

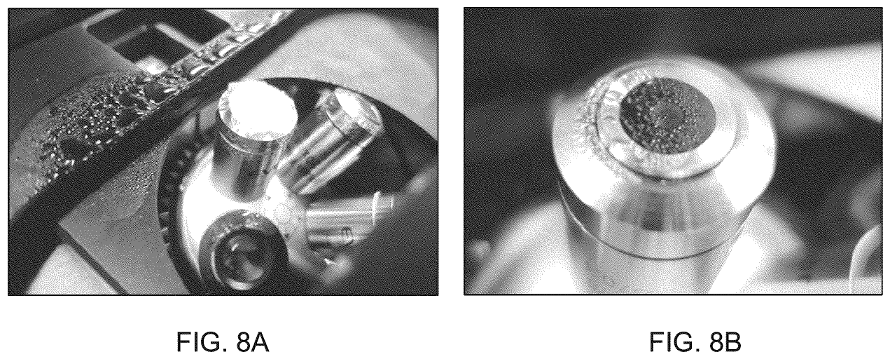

Referring now to FIGS. 8A and 8B, photographs of an objective lens 142 are shown having condensation thereon as a result of a temperature difference between the objective lens 142 and a prior art specimen container. As shown in these photographs, the objective lens 142 has accumulated a significant amount of condensation thereon, which can significantly obstruct the images obtainable by the objective lens 142, and can require time and effort to remove based on prior art techniques.

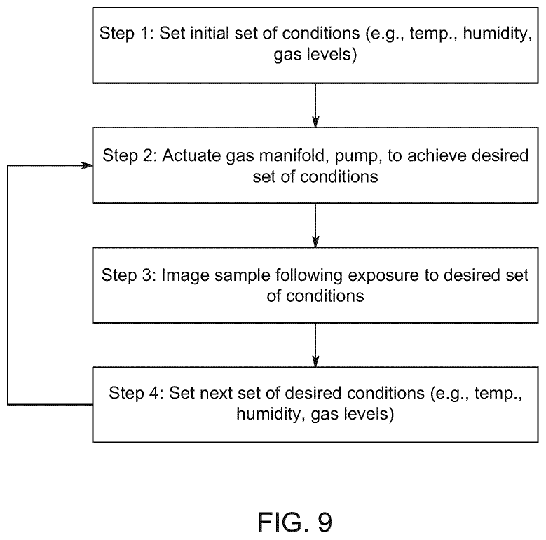

Referring now to FIG. 9, a process flow is shown for an exemplary method according to the present disclosure. As shown, at step 1, a user can set a first set of desired conditions for the interior 135 of the specimen chamber 106 for instance, temperature, humidity, gas levels to which a sample within the specimen chamber 106 will be exposed. The user can then, for example, in an automated fashion at step 2, actuate the gas manifold 110, pump 108, and other features of the disclosed incubator 100 to achieve the desired set of conditions. The user can then, at step 3, image a sample located within the interior 135 of the specimen chamber 106 following exposure to the set of conditions for the desired period of time. The user can then, at step 4, set a next set of desired conditions such as environmental conditions for the interior of the specimen chamber 106. For example, the environmental conditions include a specified temperature, humidity, and/or gas mixture levels or gas mixture composition to which a sample within the specimen chamber 106 is exposed, and then perform the foregoing steps as needed.

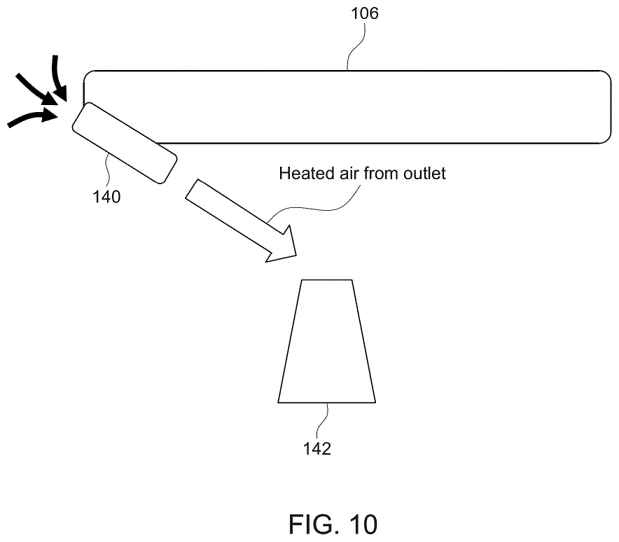

Referring now to FIG. 10, a schematic is shown depicting an exemplary airflow provided by the air actuation unit 132 according to another embodiment of the present disclosure. In particular, in this embodiment, ambient air 99a is inducted into and through the air actuation unit 132, and is directed out of the one or more outlet ports 140, as expelled air 99b, in a direction that intersects an objective lens 142 of a microscope that is present beneath the specimen chamber 106. As in the embodiments above, the inducted ambient air 99a of the present embodiment can be heated by heater 138 (see FIG. 4B) as the air travels through the air actuation unit 132, and can then be directed as expelled air 99b toward, across, or adjacent the objective lens 142 in order to dry or remove any condensation that may have accumulated and/or or prevent the accumulation of any condensation on the objective lens 142, thereby improving image quality.

An advantage to the disclosed design of the specimen chamber 106 includes improved uniformity in heating across the incubated samples located in the chamber. Table 1 provides test data showing an array of temperature measurements taken at various positions within a 96-well sample plate incubated within a specimen chamber 106 as described herein.

TABLE 1
Array of Temperature Measurements from various wells of a sample plate
incubated in a chamber as contemplated by the present disclosure.
Sample Plate Column Labels

| | | 1 | 2 | 3 | 4 | 5 | 6 | 7 | 8 | 9 | 10 | 11 | 12 |
|---|---|---|---|---|---|---|---|---|---|---|---|---|---|
| Sample | A | 35.8° C. | | | | | 36.3° C. | | | | | | 35.6° C. |
| Plate | B | 35.9° C. | | | | | 36.5° C. | | | | | | |
| Row | C | | | | | | | | | | | | |
| Labels | D | 36.3° C. | | | | | | 37.1° C. | | | | | |
| | E | | | | | | 36.7° C. | | | | | | 35.8° C. |
| | F | | | | | | | | | | | | |
| | G | 35.8° C. | | | | | 36.4° C. | | | | | | |
| | H | 35.6° C. | | | | | 35.9° C. | | | | | | 35.9° C. |

The test results shown in Table 1 demonstrate that comparatively uniform heating is obtained and maintained within a sample plate incubated within a specimen chamber 106 of the present disclosure. The maximum temperature measured in the sample plate was 37.1° C. and the minimum temperature measured was 35.6° C., with a difference of 1.5° C. The greater uniformity of heating achieved with the specimen chamber 106 of the present disclosure provides improvements in experimental design and experimental results obtained from samples contained within a specimen chamber 106 as disclosed herein.

It should be appreciated that the specimen chamber 106 can be adapted to as needed to receive sample containers of various sizes and shapes.

It should also be appreciated that in additional embodiments, the incubator system 100 can be provided in a kit that includes a specimen chamber 106 and a plurality of sample containers (e.g., vessel holders or plates) having different sizes and shapes, and which can be interchangeable with each other in the specimen chamber 106.

In should further be appreciated that, in additional embodiments, an air actuation unit can employ compressed air, as an alternative to a fan 180, to inhibit or at least reduce accumulation of condensation and/or fogging on the imaging lens. In such embodiments, the air actuation unit can include a reservoir of compressed air and a nozzle through which the compressed air can be released and directed toward, across, or adjacent the imaging lens. In this manner, the compressed air can create a pressure differential in the target location between the specimen chamber and the imaging lens. Such a pressure differential can be employed to lower the dew point temperature in the target location, thereby inhibiting or at least reducing the accumulation of condensation on the imaging lens and/or fogging of the imaging lens.

It should be appreciated that, according to yet additional embodiments herein, the air actuation unit 132 can be said to include a means for adjusting air conditions at a target location across, at, or adjacent an imaging lens. In such embodiments, the means for adjusting the air conditions in the target location can include a fan 180, compressed air, or other features and techniques. The air actuation unit 132 according to such embodiments can also include means for directing the conditioned air to the target location, which means can include a duct member, such as the duct member 182 described above, and can also include an outlet member, such as the outlet member 194 described above. The means for directing the conditioned air to the target location can also include fins or baffles, such as the fins 216 described above.

It should further be appreciated when a numerical preposition (e.g., “first”, “second”, “third”) is used herein with reference to an element, component, dimension, or a feature thereof (e.g., “first” sensor, “second” sensor), such numerical preposition is used to distinguish said element, component, dimension, and/or feature from another such element, component, dimension and/or feature, and is not to be limited to the specific numerical preposition used in that instance. For example, a “first” sensor can also be referred to as a “second” sensor in a different context without departing from the scope of the present disclosure, so long as said elements, components, dimensions and/or features remain properly distinguished in the context in which the numerical prepositions are used.

Although the disclosure has been described in detail, it should be understood that various changes, substitutions, and alterations can be made herein without departing from the spirit and scope of the invention as defined by the appended claims. Moreover, the scope of the present disclosure is not intended to be limited to the particular embodiments described in the specification. In particular, one or more of the features from the foregoing embodiments can be employed in other embodiments herein. As one of ordinary skill in the art will readily appreciate from that processes, machines, manufacture, composition of matter, means, methods, or steps, presently existing or later to be developed that perform substantially the same function or achieve substantially the same result as the corresponding embodiments described herein may be utilized according to the present disclosure.

### Aspects

The following Aspects are illustrative only and do not limit the scope of the present disclosure or the appended claims. Any part or parts of any one or more Aspects can be combined with any part or parts of any one or more other Aspects.
Aspect 1. A system for improved imaging, the system comprising:
a specimen chamber configured to contain a local environment therein; and
an air actuator,
the specimen chamber being configured such that air encouraged by the actuator is directed between the specimen chamber and an objective lens configured for imaging a sample within the specimen chamber, the air being directed so as to reduce or eliminate condensation on the objective lens.
Aspect 2. The system of Aspect 1, wherein the specimen chamber comprises a feature that supports a sample container disposed within the specimen chamber.
Aspect 3. The system of Aspect 1, wherein the specimen chamber comprises a lower region for engaging with a specimen container.
Aspect 4. The system of Aspect 3, wherein the lower region comprises a heating element.
Aspect 5. The system of Aspect 4, wherein the heating element is configured to heat the specimen chamber to about 37° C.
Aspect 6. The system of Aspect 4, wherein the heating element further heats the air encouraged by the air actuator.
Aspect 7. The system of Aspect 1, wherein the specimen chamber comprises a lid.
Aspect 8. The system of Aspect 7, wherein the lid comprises a heating element.
Aspect 9. The system of Aspect 8, wherein the heating element is configured to heat the specimen chamber to 37° C.
Aspect 10. The system of Aspect 1, wherein the chamber comprises a manifold and an outlet, wherein the manifold is configured to direct air encouraged by the actuator to the outlet.
Aspect 11. The system of Aspect 10, wherein the outlet is in register with the objective lens.
Aspect 12. The system of Aspect 11, wherein the outlet is moveable.
Aspect 13. The system of Aspect 12, wherein the outlet is slidable, rotatable, or both.
Aspect 14. The system of Aspect 10, wherein the manifold further comprises one or more sensors.
Aspect 15. The system of Aspect 14, wherein the one or more sensors comprise a temperature sensor.
Aspect 16. The system of Aspect 1, further comprising a control unit that delivers a conditioned air to the specimen chamber.
Aspect 17. The system of Aspect 16, wherein the control unit comprises a gas mixing manifold.
Aspect 18. The system of Aspect 17, wherein a gas mixture within the gas mixing manifold comprises one or more gases selected from oxygen, carbon dioxide, nitrogen, and standard air, the gases balanced to a selected mixture of concentrations.
Aspect 19. The system of Aspect 16, wherein the control unit comprises a pump configured to encourage the conditioned air to a fluid inlet of the specimen chamber.
Aspect 20. The system of Aspect 19, wherein the pump is positioned internal to the control unit.
Aspect 21. The system of Aspect 16, wherein the conditioned air comprises humidified air or heated humidified air.
Aspect 22. The system of Aspect 16, wherein the conditioned air comprises dried air or heated dried air.
Aspect 23. The system of Aspect 21, wherein the humidified air comprises a humidity of about 50% to about 90% humidity.
Aspect 24. The system of Aspect 18, wherein the selected mixture of concentrations comprises from about 5% to about 12% carbon dioxide.
Aspect 25. The system of Aspect 18, wherein the selected mixture of concentrations comprises up about 21% oxygen.
Aspect 26. The system of Aspect 18, wherein the selected mixture of concentrations comprises from about 67% to about 95% nitrogen.
Aspect 27. The system of any one of Aspects 1-26, wherein the system is configured for operation such that the minimum temperature among all locations of a sample container located within the sample chamber is within about 15% of the maximum temperature among all locations of the sample container.
Aspect 28. A method, comprising: operating a system according to any one of Aspects 1-27 so as (1) reduce or eliminate condensation on the objective lens, (2) maintain a first environment within the sample chamber that differs in one or more of temperature, humidity, and gas mixture relative to an ambient environment exterior to the sample chamber, or both (1) and (2).
Aspect 29. The method of Aspect 28, further comprising operating the system according to any one of Aspects 1-27 so as maintain a second environment within the sample chamber that differs in one or more of temperature, humidity, and gas mixture relative to an ambient environment exterior to the sample chamber, the second environment differing from the first environment.
Aspect 30. The method of any one of Aspects 28-29, wherein the operating is performed such that during the operating, the minimum temperature of all locations of a sample container located within the sample chamber is within about 15% of the maximum temperature of all locations of the sample container.
Aspect 31. An incubator, comprising: a specimen chamber, the specimen chamber comprising an interior and (i) a fluid inlet, (ii) a surface for receiving a specimen sample container, and (iii) one or more heating elements; and a control unit configured to engage with the specimen chamber, wherein the fluid inlet is configured to receive a conditioned air from the control unit, the specimen chamber being configured to deliver the conditioned air to the interior of the specimen chamber.

A specimen chamber can be placed on a microscope stage and/or a microscope slide. A gasket can be used to seal the specimen chamber to the microscope stage and/or slide.
Aspect 32. The incubator of Aspect 31, wherein the control unit comprises a gas mixing chamber, which is also termed a gas mixing manifold, in some instances. The gas mixing chamber can include any one or more of a valve, sensor, a filter, and/or a regulator for generating a gas mixture for delivery to the fluid inlet. One or more sensors can be positioned to monitor any one or more of a gas content, a temperature, and a humidity of the contents of the gas mixing manifold.
Aspect 33. The incubator of Aspect 32, wherein a gas mixture within the gas mixing chamber comprises one or more gases selected from oxygen, carbon dioxide, nitrogen, and standard air, the gases balanced to a selected mixture of concentrations. One or more such gases can be received from a gas source exterior to the gas mixing chamber, for example, a tank of gas. By modulating the introduction of different gases to the gas mixing chamber, the user can achieve within the gas mixing chamber a mixture according to a set specification of gas levels.
Aspect 34. The incubator of Aspect 31, wherein the conditioned air comprises humidified air or heated humidified air. A user can, for example, set a desired humidity level, which humidity level can be achieved by humidifying air drawn into the control unit, by mixing humidified air developed within the control unit with air that is drawn into the control unit, or both. It should be understood that the contents of the gas mixing manifold can be mixed with humidified air and/or non-humidified air.
Aspect 35. The incubator of Aspect 31, wherein the conditioned air comprises dried air or heated dried air. An incubator can include a dehumidifier, for example, a dehumidifier configured to dehumidify air that is delivered via the connector to the inlet of the specimen chamber.
Aspect 36. The incubator of Aspect 31, further comprising a lid.
Aspect 37. The incubator of Aspect 36, wherein the lid comprises (i) a thermally insulating film coating, (ii) a conductive heater, or both. A lid can be connected to a power supply, which power supply in turn acts to heat the lid. A lid can also comprise a power source, for example, a battery, which power source is used to energize a heater of the lid.
Aspect 38. The incubator of Aspect 31, wherein the control unit comprises a pump configured to encourage the conditioned air into the fluid inlet.
Aspect 39. The incubator of Aspect 38, wherein the pump is positioned internal to the control unit.
Aspect 40. The incubator of Aspect 34, wherein the humidified air is humidified to from about 50% to about 90% humidity, preferably about 80% humidity. Humidity levels of from 50% to 90%, 55% to 85%, 60% to 80%, or even 70% are all suitable.
Aspect 41. The incubator of Aspect 33, wherein the selected mixture comprises from about 5% to about 12% carbon dioxide, preferably about 5% carbon dioxide. Carbon dioxide levels of from about 5% to about 12%, from about 6% to about 11%, from about 7% to about 10%, or even from about 8% to about 9% are all considered suitable.
Aspect 42. The incubator of Aspect 33, wherein the selected mixture comprises up to about 21% oxygen. The mixture can have less than 21% oxygen, e.g., from about 0.5% to about 20%, from about 1% to about 19%, from about 2% to about 18%, from about 3% to about 17%, from about 4% to about 16%, from about 5% to about 15%, from about 6% to about 14%, from about 7% to about 13%, from about 8% to about 12%, from about 9% to about 11%, or even about 10%.
Aspect 43. The incubator of Aspect 33, wherein the selected mixture comprises from about 67% to about 95% nitrogen, preferably about 75% nitrogen. The mixture can have from about 67% to about 95% nitrogen, or from about 70% to about 90% nitrogen, or from about 75% to about 85% nitrogen, or even about 80% nitrogen.
Aspect 44. The incubator of Aspect 34 or 35, wherein the conditioned air is heated to about 37° C. This is not a requirement, however, as conditioned air can be heated to, for example, about 20° C., about 25° C., about 30° C., or even about 35° C.
Aspect 35. The incubator of Aspect 31, wherein the one or more heating elements are configured to heat the specimen sample container to about 37° C.
Aspect 46. The incubator of Aspect 31, further comprising a manifold configured to receive the conditioned air.
Aspect 47. The incubator of Aspect 36, wherein the manifold is configured to distribute the conditioned air within the interior of the specimen chamber. The manifold can extend around part of or even around the entirety of a perimeter (inner or outer) of the interior of the specimen chamber.
Aspect 48. The incubator of any one of Aspects 46-47, further comprising at least one vent in fluid communication with the manifold, the at least one vent being configured to direct conditioned air received from the control unit to the specimen sample container. The conditioned air directed to the specimen sample container can be heated by the one or more heating elements of the specimen chamber.
Aspect 49. The incubator of Aspect 31, further comprising an air circulator embodied in the specimen chamber, the air circulator configured to encourage air beneath the specimen sample chamber. Such air can be used to reduce or even eliminate fogging of an objective lens positioned beneath the specimen sample chamber.
Aspect 50. The incubator of Aspect 49, wherein the air actuator comprises a fan.
Aspect 51. The incubator of any one of Aspects 31-50, further comprising at least one sensor configured to detect a humidity, a gas level, or both.
Aspect 52. The incubator of any one of Aspects 31-51, further comprising a water reservoir, the water reservoir being in fluid communication with and/or embodied within the control unit, the water reservoir is in fluid communication with the fluid inlet.
Aspect 53. The incubator of any one of Aspects 31-53, wherein the incubator is configured to include in the conditioned air (i) the gas mixture, (ii) humidified air, or both (i) and (ii).
Aspect 54. The incubator of any one of Aspects 31-53, wherein the incubator modulates an atmosphere within the interior of the specimen chamber to at least one specified level of any one or more conditions selected from: oxygen level, carbon dioxide level, nitrogen level, percent humidity, or temperature.
Aspect 55. The incubator of Aspect 31, wherein the gas mixing chamber mixes gases received from external to the incubator.
Aspect 56. The incubator of Aspect 31, wherein the incubator is configured for mounting on a microscope stage.
Aspect 57. The incubator of Aspect 31, wherein the chamber comprises one or more ports configured for introducing or removing one or more materials to or from the interior of the specimen chamber.
Aspect 58. A method for imaging a specimen in a controlled environment, comprising: positioning the specimen within the specimen chamber of an incubator according to any one or Aspects 31-57; and acquiring one or more images of the specimen in the specimen chamber. Image acquisition can be, e.g., via an inverted microscope.
Aspect 59. The method of Aspect 58, further comprising exposing the specimen positioned within the specimen chamber to a first set of environmental conditions in an atmosphere of the interior of the specimen chamber for a first interval of time.
Aspect 60. The method of Aspect 59, wherein the first set of environmental conditions comprises a first specified level of one or more of: oxygen, carbon dioxide, nitrogen, humidity, temperature, or one or more combinations thereof.
Aspect 61. The method of Aspect 59, wherein the first set of environmental conditions includes a condition that differs from a corresponding condition of an atmosphere exterior to the specimen chamber.
Aspect 62. The method of any one of Aspects 58-61, wherein the first interval of time is in the range of from about 1 minute to 72 hours or more. Intervals of, e.g., from about 1 minute to 72 hours or more, from about 1 minute to 48 hours, from about 5 minutes to 24 hours, from about 10 minutes to 20 hours, from about 30 minutes to 10 hours, and from 1 hour to 5 hours are all considered suitable.
Aspect 63. The method of any one of Aspects 58-62, further comprising exposing the specimen to a second set of environmental conditions in the interior of the specimen chamber for a second interval of time.
Aspect 64. The method of Aspect 63, wherein the second set of environmental conditions includes a condition, including for example, temperature, humidity, and/or gas mixture, that differs from a corresponding condition of the first set of environmental conditions. The second interval of time can differ from the first interval of time.
Aspect 65. The method of any one of Aspects 58-64, further comprising introducing one or more reagents into the specimen chamber.
Aspect 66. The method of any one of Aspects 58-65, further comprising extracting one or more samples from the specimen chamber.

What is claimed is:

1. A specimen chamber for use with a sample imager, comprising:
a chamber housing comprising:
a first face and a second face opposite each other along a first direction, wherein the first face is configured to face an imaging lens, the second face is configured to mount with a lid having a window, and the first face is spaced from the second face in a lens-facing direction along the first direction;
first and second endwalls opposite each other along a second direction substantially perpendicular to the first direction; and
first and second sidewalls opposite each other along a third direction substantially perpendicular to the first and second directions,
wherein the first and second endwalls and the first and second sidewalls substantially enclose an interior volume with respect to the first and second directions, and the interior volume is configured to contain a local environment therein; and
an air actuator unit configured to direct conditioned air to a target location alongside the first face and spaced from the first face in the lens-facing direction for inhibiting or at least reducing condensation accumulation on the imaging lens.

2. The specimen chamber of claim 1, wherein the air actuator unit comprises an air actuator, a duct member, and an outlet port, wherein the air actuator is configured to induct air from exterior of the specimen chamber and direct the inducted air into a channel defined by the duct member, wherein the channel is configured to direct the inducted air to the outlet port, such that the inducted air exits the outlet port and travels exterior to and alongside the second face of the chamber housing.

3. The specimen chamber of claim 2, wherein the air actuator comprises a fan.

4. The specimen chamber of claim 2, wherein the air actuator unit comprises an outlet member in communication with the duct, the outlet member at least partially defining an outlet passageway that terminates at the outlet port.

5. The specimen chamber of claim 4, wherein the outlet member comprises fins that protrude within the outlet passageway and are configured to direct the flow of air exiting the outlet port.

6. The specimen chamber of claim 5, wherein the fins are elongated along respective directions that diverge from each other in a downstream direction, thereby causing the inducted air to spread outwardly as the inducted air exits the outlet port.

7. The specimen chamber of claim 5, wherein the outlet member has an outlet base surface that at least partially defines the outlet passageway, the fins extend from the outlet base surface along a direction opposite the lens-facing direction, and the outlet base surface is substantially parallel with the first face of the chamber housing, thereby causing the inducted air to exit from the outlet member in respective air flow directions that are substantially parallel with the first face of the chamber housing.

8. The specimen chamber of claim 7, wherein the outlet base surface faces a portion of the first face of the chamber housing, such that the portion of the first face partially defines the outlet passageway.

9. The specimen chamber of claim 2, further comprising a heating element configured to heat the interior volume of the specimen chamber.

10. The specimen chamber of claim 9, wherein the heating element is configured to heat the interior volume of the specimen chamber to a temperature in a rang of about 30° C. to about 40° C.

11. The specimen chamber of claim 9, wherein at least a portion of the heating element is adjacent to the channel, such that the inducted air is directed along the at least the portion of the heating element, wherein the inducted air is heated by the heating element.

12. The specimen chamber of claim 1, further comprising at least one temperature sensor configured to measure temperature at the target location.

13. The specimen chamber of claim 1, further comprising the lid, wherein the lid is configured for repeated attachment to and detachment from the second face of the chamber housing, and the lid comprises at least one of a heating element or a thermal insulating layer.

14. The specimen chamber of claim 13, wherein the lid comprises a lid heating element, and the lid hearing element is configured to heat the specimen chamber to a temperature in a range of about 30° C. to about 40° C.

15. A system for sample imaging, the system comprising:
a control unit for delivering conditioned air; and
a specimen chamber comprising:
a chamber housing having an upper face, a lower face opposite the upper face, and walls that extend vertically between the upper and lower faces, wherein the walls define an interior volume of the specimen chamber, and the lower face is configured to face an imaging lens; and
an air actuator unit configured to direct conditioned air to a target location alongside the lower face for inhibiting or at least reducing condensation accumulation on the imaging lens.

16. The system of claim 15, wherein the air actuator unit comprises an air actuator, a duct member, and an outlet port, wherein the air actuator is configured to induct air from exterior of the specimen chamber and direct the inducted air into a channel defined by the duct member, wherein the channel is configured to direct the inducted air to the outlet port, such that the inducted air exits the outlet port and travels exterior to and alongside the second face of the chamber housing.

17. The system of claim 16, wherein the air actuator comprises a fan, and the specimen chamber comprises at least one heater located alongside the channel, wherein the at least one heater is configured to heat the inducted air prior to the inducted air existing the outlet port.

18. The system of claim 17, wherein the outlet port includes fins that are elongated along respective directions that diverge from each other in a downstream direction, thereby causing the inducted air to spread outwardly as the inducted air exits the outlet port.

19. The system of claim 15, further comprising the lid, wherein the lid is configured for repeated attachment to and detachment from the upper face of the chamber housing, and the lid comprises at least one of a heating element or a thermal insulating layer.

20. The system of claim 19, wherein the lid comprises a lid heating element, and the lid hearing element is configured to heat the specimen chamber to about 37° C.
